(19) United States
(12) Patent Application Publication
(10) Pub. No.: US 2026/0194238 A1
(43) Pub. Date: Jul. 9, 2026

(54) AN APPLIANCE

(71) Applicant: BREVILLE PTY LIMITED, Alexandria, NSW (AU)

(72) Inventors: David Paul GARGIULO, Alexandria, NSW (AU); Daniel James BUCKLAND, Alexandria, NSW (AU)

(21) Appl. No.: 19/133,858

(22) PCT Filed: Dec. 4, 2023
(86) PCT No.: PCT/AU2023/051246

§ 371 Date: May 29, 2025

(30) Foreign Application Priority Data
Dec. 5, 2022 (AU) 2022903704

(51) Int. Cl. F24C 15/02; A47J 37/06

(52) U.S. Cl. CPC F24C 15/023; A47J 37/0641; A47J 37/0664; F24C 15/022

(57) ABSTRACT

Disclosed herein is an appliance having a body defining an opening and a door operable to selectively occlude the opening; wherein, the door is configurable into: a first condition whereby the door is slidable between a slidable open position and a slidably closed position; and, a second condition whereby the door is pivotable between a pivotably open position and a pivotably closed position.

### FIELD

The present invention relates to an appliance, and in particular, an appliance having a door configurable into alternative modes of operation.

### BACKGROUND

Many different household appliances such as kitchen and cooking appliances are available for performing a wide range of tasks. New appliances with new functions are continually developed and brought to market, offering consumers considerable choice. Some appliances are versatile and are able to perform commonly used tasks and/or a range of different tasks. Other appliances may have specialised use for a single task, a task that is not often required, or a task that is difficult to replicate by other means.

Given the large and increasing amount of appliances available to the consumer, they may not be able to acquire certain appliances owing to considerations such as cost, kitchen bench space, storage cupboard space and the like. Consumers may also desire certain appliances having a certain function, but may feel that certain function may not offer enough value to warrant purchase of the appliance, perhaps due to their impression that task is rather specialised or unlikely to be performed often, in addition to the preceding considerations. Instead, they may attempt to perform that task with their existing appliances, which often results in considerable inconvenient, time burdens and unsatisfactory culinary outcomes.

Certain products attempt to incorporate the functionality of multiple tasks with varying success. Such an approach often involves considerable trade-offs in product design which can compromise the efficacy of certain tasks as well as the user experience and satisfaction in performing the task. Often, incorporation of multiple task functionality in an appliance results in some or all of the tasks not being performed to standard of a standalone product performing a particular task. Other such appliances are often designed around one or perhaps two main tasks, with the appliance mimicking the design of that main task, and so not provide the user experience associated with the other tasks.

Incorporating multiple tasks typically performed by standalone appliances into a single appliance presents considerable challenges to avoid or minimise compromising factors such as ease of use, reliability, product safety, range of features associated with the tasks, accessories and the user experience of the appliances operating in the manner associated with the different standalone appliances typically used to perform the particular tasks, while also attempting to provide an attractive value proposition to the consumer.

### SUMMARY

It is an object of preferred embodiments of the invention to address the disadvantages described above and/or to at least provide the public with a useful choice.

In accordance with an aspect of the present invention, disclosed is an oven having a body defining an interior chamber to receive foodstuffs and a door operable to selectively occlude the interior chamber; wherein, the door is mounted to the body by way of a mounting assembly including: a sliding portion configured to extend from the body such that the door is slidable between a slidably open and a slidably closed position relative the body; and, a pivoting portion such that the door is pivotable between a pivotably open and a pivotable closed position.

In certain embodiments the mounting assembly includes a fixed portion adapted for connection to the oven body in a fixed relation, wherein the sliding portion retracts relative the fixed portion towards the slidably closed position, and extends relative the fixed portion towards the slidably open position

In certain embodiments the fixed portion is configured to substantially locate within the body.

In certain embodiments the sliding member is in telescoping arrangement with the fixed member.

In certain embodiments the pivoting portion acts between the door and the sliding portion such that the door is pivotable in relation to the sliding portion.

In certain embodiments the door is configurable into: a first condition latched in the slidably closed position, and pivotable between the pivotably open position allowing access to the interior chamber and the pivotably closed position restricting access to the interior chamber; and, a second condition latched in the pivotably closed position, and slidable between the slidably open position allowing access to the interior chamber and the slidably closed position restricting access to the interior chamber.

In certain embodiments the door is user selectable into the first condition or the second condition.

In certain embodiments the door is user selectable into the first condition or the second condition by way of an actuator assembly.

In certain embodiments the actuator assembly includes an actuator positioned on the door.

In certain embodiments the oven further includes a recess formed in the upper edge periphery of the door, and a sealing member operable to selective occlude the recess.

In certain embodiments the sealing member is operatively connected with the actuator assembly, and wherein operation of the actuator to select the first condition of the door correspondingly places the sealing member into position to occlude the recess, and operation of the actuator to select the second condition correspondingly places the sealing member into position to expose the recess.

In certain embodiments the actuator is operatively associated with a cam adapted to place the sealing member into position to occlude the recess.

In certain embodiments the sealing member is biased into position to expose the recess.

In certain embodiments the recess is adapted to receive an oven accessory.

In certain embodiments the actuator is a handle rotatable to select the first position or the second position, wherein the handle is orientated downwards to select the second condition, wherein the recess is adapted to receive a first portion of an oven accessory, said first portion sized to occlude the recess when received thereby.

In certain embodiments the oven includes a selector assembly operatively associated with the actuator assembly to select either the first condition or the second condition.

In certain embodiments the selector assembly includes a first engagement member having an engaged position whereby the pivoting portion is latched in the pivotably closed position; and, a disengaged position wherein the pivoting portion is unlatched for movement between the pivotably closed and the pivotably open position.

In certain embodiments the selector assembly includes a second engagement member having an engaged position whereby the sliding portion is latched in the slidably closed position; and, a disengaged position wherein the sliding portion is unlatched for movement between the slidably closed and the slidably open position.

In certain embodiments the first engagement member and the second engagement member are in an interlockable relation with said first condition and said second condition being mutually exclusive.

In certain embodiments the first engagement member and the second engagement member are operatively connected, and wherein configuring one of the first or second engagement members into the engaged position will correspondingly configure the other of the first and second engagement members into the disengaged position.

In certain embodiments the first engagement member and the second engagement member are operatively connected, and wherein configuring one of the first or second engagement members into the disengaged position will correspondingly configure the other of the first and second engagement members into the engaged position.

In certain embodiments the first engagement member and the second engagement member are operatively connected whereby actuation of the first engagement into the disengaged position correspondingly actuates the second engagement member into the engaged position thereby defining the first condition of the door.

In certain embodiments the first engagement member and the second engagement member are operatively connected whereby actuation of the first engagement into the engaged position correspondingly actuates the second engagement member into the disengaged position thereby defining the second condition of the door.

In certain embodiments the actuator is operable to actuate the first engagement member into the disengaged or engaged position.

In certain embodiments the first engagement member is mounted in association with the door.

In certain embodiments the first engagement member locates within the door, between an outer surface of the door and an inner surface of the door.

In certain embodiments the first engagement member is mounted to a frame within the door.

In certain embodiments the first engagement member is biased into its engaged position.

In certain embodiments the first engagement member is a bolt configured to reciprocate between its engaged position and its disengaged position.

In certain embodiments the first engagement member is configured to be received by a bolt keeper associated with the sliding portion when the first engagement member is in the engaged position thereby defining the second condition of the door.

In certain embodiments the first engagement member is biased into the disengaged position out of engagement with the bolt keeper.

In certain embodiments the bolt keeper is an aperture in the sliding portion.

In certain embodiments the actuator is operable to actuate the second engagement member into the disengaged or engaged position.

In certain embodiments the second engagement member is mounted in association with the sliding portion.

In certain embodiments the second engagement member is a latch having a fulcrum mounted in fixed relation to the sliding portion

In certain embodiments the latch has a latching end pivotable about the fulcrum in a first direction into the engaged position and a second direction into the disengaged position.

In certain embodiments the latch has a second end opposite the fulcrum to the first end, said second end locating proximal to an aperture in the sliding portion defining the bolt keeper, whereby actuation of the first engagement member into the engaged position received by the bolt keeper causes the first engagement member to impinge on the second end of the second engagement member thereby pivoting the first end of the second engagement member about the fulcrum into the disengaged position.

In certain embodiments the second engagement member is biased into the engaged position.

In accordance with an aspect of the present invention, disclosed is an oven accessory for use with the oven of one or more of the preceding embodiments, the oven accessory having a first portion sized to occlude the recess when received thereby.

In certain embodiments the oven accessory further having a second portion adapted to receive the handle selecting the second condition.

In certain embodiments the second portion is adapted to slip over the handle selecting the second condition.

In certain embodiment the oven accessory is an air fryer basket.

In accordance with an aspect of the present invention, disclosed is an appliance having a body defining an opening and a door operable to selectively occlude the opening; wherein, the door is configurable into: a first condition whereby the door is slidable between a slidable open position and a slidably closed position; and, a second condition whereby the door is pivotable between a pivotably open position and a pivotably closed position.

### BRIEF DESCRIPTION OF THE DRAWINGS

Preferred embodiments of the invention will now be described, by way of non-limiting example, with reference to the accompanying drawings in which:

FIG. 1 depicts a schematic perspective view of an example embodiment of an appliance according to the present disclosure with a closed door in its first condition.

FIG. 2 depicts the appliance of FIG. 1 with an open door in its first condition.

FIG. 3 depicts the appliance of FIG. 1 with a closed door in its second condition.

FIG. 4 depicts the appliance of FIG. 1 with an open door in its second condition.

FIG. 5 depicts the appliance of FIG. 1 with an open door in its second condition, with a fitted accessory.

FIG. 6 depicts the appliance of FIG. 1 with a closed door in its second condition, with a fitted accessory.

FIG. 7 depicts a schematic rear sectional view of an example embodiment of an appliance door according to the present disclosure in its first condition.

FIG. 8 depicts the appliance door of FIG. 7 in its second condition.

FIG. 9 depicts a schematic perspective view of an example embodiment of an appliance door according to the present disclosure.

FIG. 10 depicts a schematic partial sectional view of an example embodiment of an appliance according to the present disclosure with a closed door in its first condition.

FIG. 11 depicts the appliance of FIG. 10 with an open door in its first condition.

FIG. 12 depicts the appliance of FIG. 10 with a closed door in its second condition.

FIG. 13 depicts the appliance of FIG. 10 with an open door in its second condition.

### DESCRIPTION OF EMBODIMENTS

Disclosed herein is an appliance and a door for an appliance having alternative modes of operation, namely that the door can pivot between opened and closed positions in a manner like that of conventional overs; and can slide between open and closed positions in a manner like that of a drawer. The door may be operatively connected to the oven using an extendable track facilitating the sliding function of the door. The door may be pivotally connected to the track facilitating the pivoting function of the door. The following preferred embodiments are provided by way of example only, and should not be construed as providing limitations on the claims, nor should particular features be construed as essential to the invention by virtue of being described in relation to a preferred embodiment. It is envisaged that the invention of the present disclosure may find use in an appliance having a conventional oven function and an air fryer function. It is envisaged that the pivoting door mode may be associated with the conventional oven function and the sliding door mode may be associated with the air fryer function, however the invention should not be construed as being limited to this application.

With reference to the Figures, disclosed is an appliance 1 having a body 100 with an opening 101 and a door 103 operable to selectively occlude the opening 101. The door 103 is configurable into alternate modes of operation. In a first condition, the door 103 is pivotable between an open and closed position. In a second condition, the door 103 is slidable between an open and closed position.

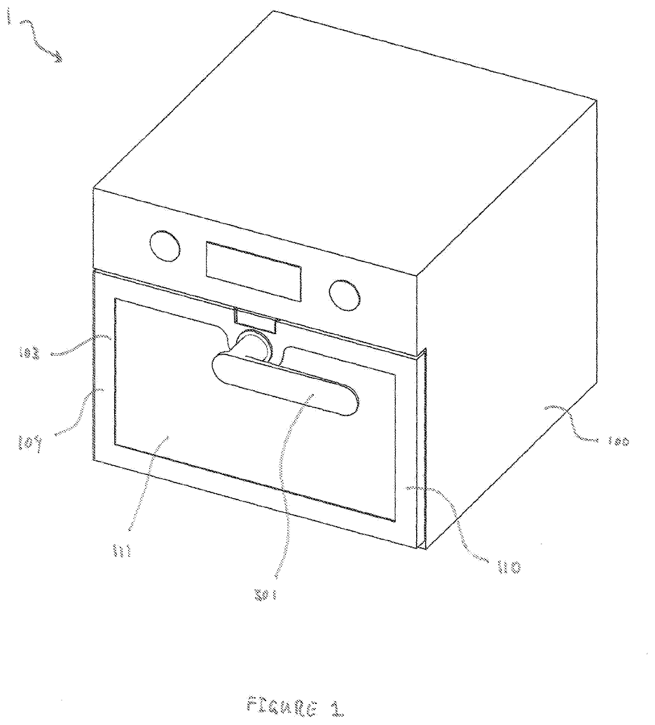

With reference to FIG. 1, shown is a non-limiting example embodiment of an appliance 1 in the form of an oven with its door 103 in a closed position occluding the opening 101 to the interior chamber 102 of the oven 1 wherein foodstuffs are placed for cooking. This example oven 1 includes a handle 301 locating on its door 103 facilitating a user to open and close the door 103.

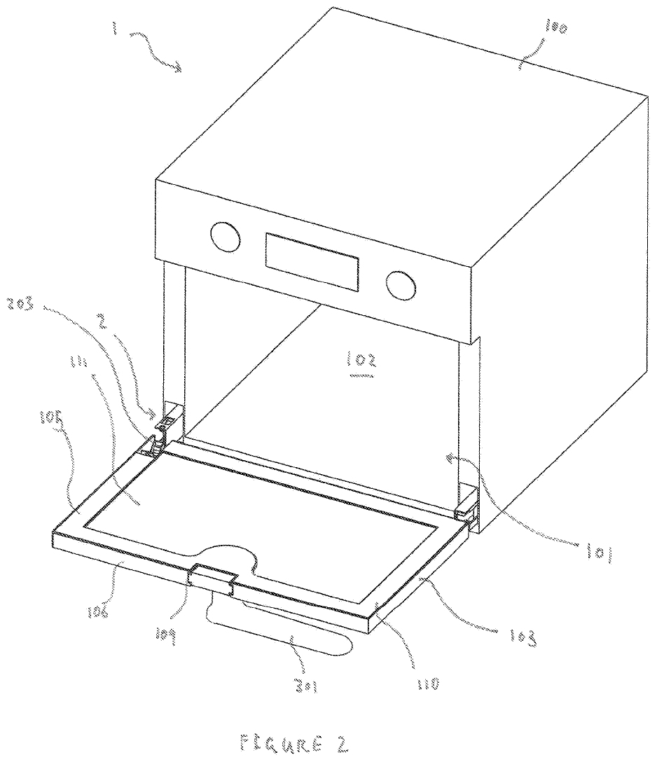

With reference to FIG. 2, shown is a non-limiting example embodiment of an appliance in the form of an oven 1 in the first condition with its door 103 pivoted into an open position revealing the opening 101 and the interior chamber 102. The oven 1 of FIG. 2 is in its first condition, where the door 103 has a pivoting mode of function like that typical of conventional ovens. The pivoting axis is horizontal at a lower periphery of the door 103, such that it is pivoted in a downwards direction into its open position as shown in FIG. 2, and pivoted upwards into its closed position as shown in FIG. 1.

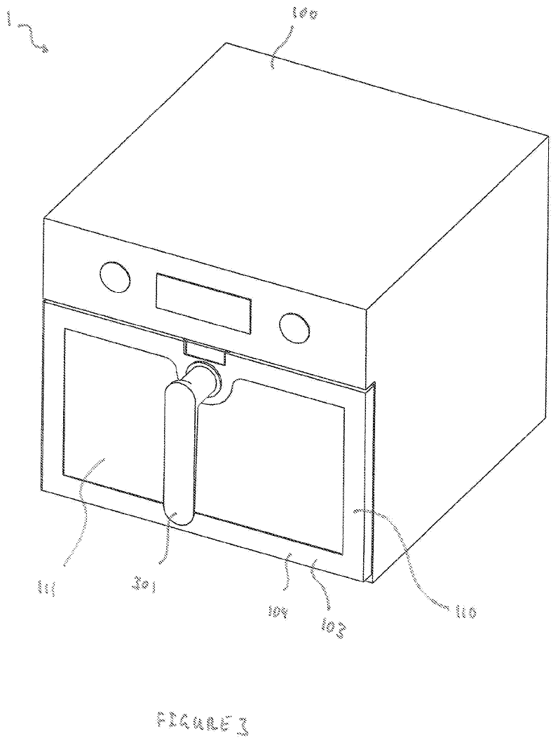

With reference to FIG. 3, shown is a non-limiting example embodiment of an appliance in the form of an oven 1 with its door 103 in a closed position occluding the opening 101 to the interior chamber 102 of the oven 1 wherein foodstuffs are placed for cooking. In this example embodiment, the handle 301 is part of an actuation assembly 3 operable to select the operational mode of the door 103. Accordingly, the FIG. 3 handle 301 serves a dual purpose of an actuator 301 for selecting the operational mode of the door 103, and as a handle for a user to move the door 103. However, it is to be appreciated that other example embodiments may separately provide said handle function and actuation function in separate components without departing from the scope of the present disclosure.

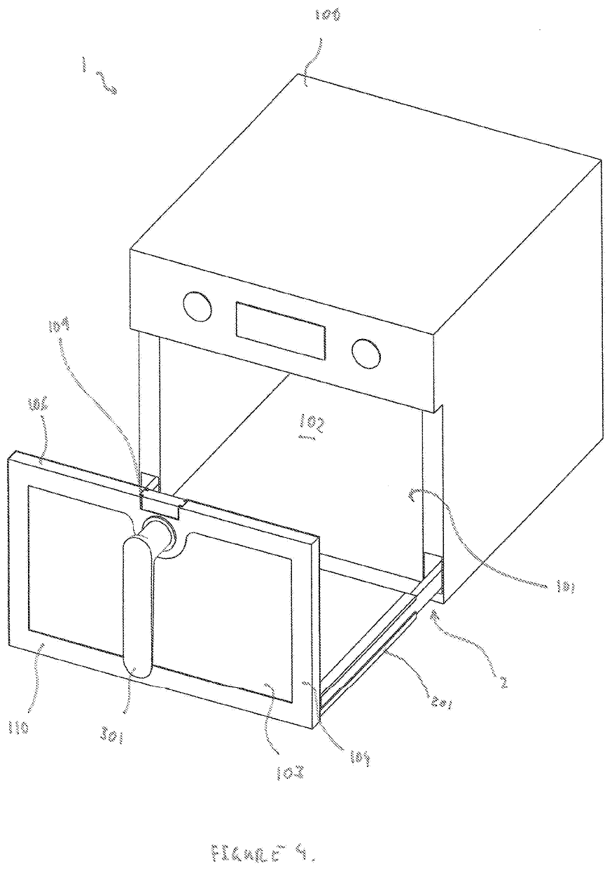

With reference to FIG. 4, shown is a non-limiting example embodiment of an appliance in the form of an oven 1 in the second condition with its door 103 slid into an open position revealing the opening 101 and the interior chamber 102. Such functionality may be affected using sliding tracks, runners or the like acting between the door 103 and the oven body 100, with such track arms extending from the body 100 when the door 103 is slidably opened like shown in FIG. 4, and the track arms retracting within the body 100 like as shown in FIG. 2. Such sliding or extendable tracks typically involve a sliding portion 201 like an arm mounted in association with the door 103 that is extendable relative to some fixed portion 202 mounted in association with the body 100.

The example door 103 in the second condition depicted by FIGS. 3 and 4 is translatable along an extension axis between the closed position of FIG. 3 and the open position of FIG. 4. Unlike the first condition, the example embodiment door 103 in the second condition does not substantially change its angular orientation as it is translated open. Instead, the plane of the door 103 remains substantially parallel with the plane of the opening 101 as it slid open and displaced from the opening 101.

In a non-limiting example embodiment, the actuator 301 may be turned to select either the first condition or the second condition of the door 103. In the depicted example embodiment of FIGS. 1 to 4, the handle 301 may be turned to a vertically downwards position to affect the second condition of the door 103 like as shown in FIGS. 3 and 4 wherein the door 103 may be slide like a draw; and the handle may be turned to a horizontal position to affect the first condition of the door 103 wherein the door 103 is pivotable like as shown in FIGS. 1 and 2. With the mode of operation thus selected, the depicted example actuator 301 may be used as a handle to operate the door 103 between open and closed positions.

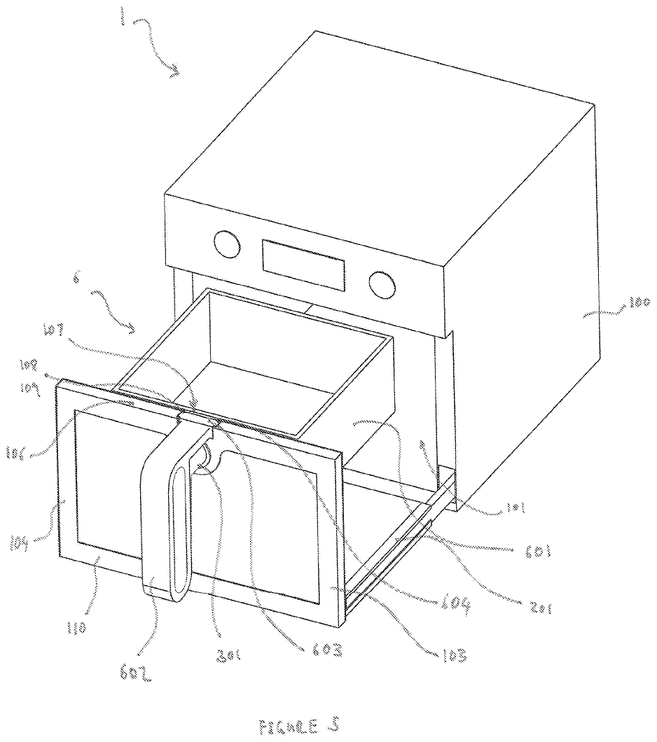

With reference to FIG. 5, shown is a non-limiting example embodiment of an appliance in the form of an oven 1 with its door 103 slid into an open position revealing the opening 101 and the interior chamber 102. FIG. 5 depicts the example oven 1 with its door 103 opened in the second condition displaced from the opening 101 along its extension axis. FIG. 5 also depicts an example embodiment of a removable accessory 6 used in association with the oven 1. The example accessory 6 has an internal portion 601 adapted to reside within the interior chamber 102 when cooking. In the depicted embodiment the internal portion 601 is an air-fryer basket, however the internal portion 601 may be in the form of any desired apparatus, such as a tray, rack, steamer, a poacher or a fish kettle by way of non-limiting example.

The example apparatus of FIG. 5 also includes an external portion 602 adapted to situate external of the interior chamber 102 when the door 103 is closed. The external portion 602 may incorporate a hand-grip as depicted to facilitate user-handling of the accessory 6.

The external portion 602 may also be adapted to restrict access to the actuator 301. Additionally or alternatively, the external portion 602 may be adapted to restrict operation of the actuator 301 from changing the operating mode of the door 103 when the accessory 6 is in its in-use position connected with the door 103. In the depicted example embodiment, the actuator 301 is an elongated handle orientated vertically downwards when the door 103 is in the second condition operable by translating along the door 103 extension axis. With the door 103 opened in its second condition, the accessory 6 can be lowered into its in-use position shown in FIG. 5, with the internal portion 601 and external portion 602 situating on either side of the door 103. In one example embodiment, the external portion 602 may be slotted or channelled to receive the actuator 301 as the accessory 6 is lowered into position. By this arrangement with the accessory 6 in its in-use position, the actuator 301 is captured by the slot or channel of the accessory 6 handgrip and is thus restricted from being turned to affect the first condition, effectively locking the door 103 in its second condition. In an alternative embodiment, the external portion 602 is not slotted to engage with the handle, but rather is simple adapted to site proximally to the handle in a manner that obscures access, making it difficult for a user to accidentally turn the handle to effect the first condition when the accessory 6 is in-use connected with the door 103.

The example apparatus of FIG. 5 also includes a connecting portion 603 for attaching the accessory 6 to the door 103 when in-use. In embodiments, an upper edge periphery 106 of the door 103 may be notched or have a recess 107 for engagingly receiving the connecting portion 603. The recess 107 in FIG. 5 is centrally located along the upper edge periphery 106, though other arrangements are possible depending on the dimensions of the accessory 6. In an alternative example, the door 103 may additionally or alternatively feature a pair of recesses 107 spaced from the centre, allowing two smaller accessories to that depicted in FIG. 5 to be used side-by-side. The door recess 107 may be sealable to fill the recess 107 when not in use by the accessory 6.

The recess 107 may have engaging features 109 for stably receiving the connecting portion 603 of the accessory 6. The connecting portion 603 of the accessory 6 may have corresponding engaging features 604 to interact with those of the recess 107. In the example embodiment of FIG. 5, the sidewalls 108 defining the recess 107 are profiled with vertical slots or grooves, thus forming the engaging features 109. The connecting portion 603 has corresponding flanges or projections configured to be received by the vertical slots or grooves 109 in the recess sidewall 108 such that movement of the in-use accessory 6 is effectively limited to upwards translation to lift slide the flanges 604 out of engagement with the slots 109 thus removing the connecting portion 603 and accessory 6 from connection with the door 103.

With the accessory 6 in its in-use position depicted in the example embodiment of FIG. 5, the recess 107 is occupied by the accessory 6, thereby acting to restrict heat transfer from the interior chamber 102 through the recess 107 when the appliance is in use.

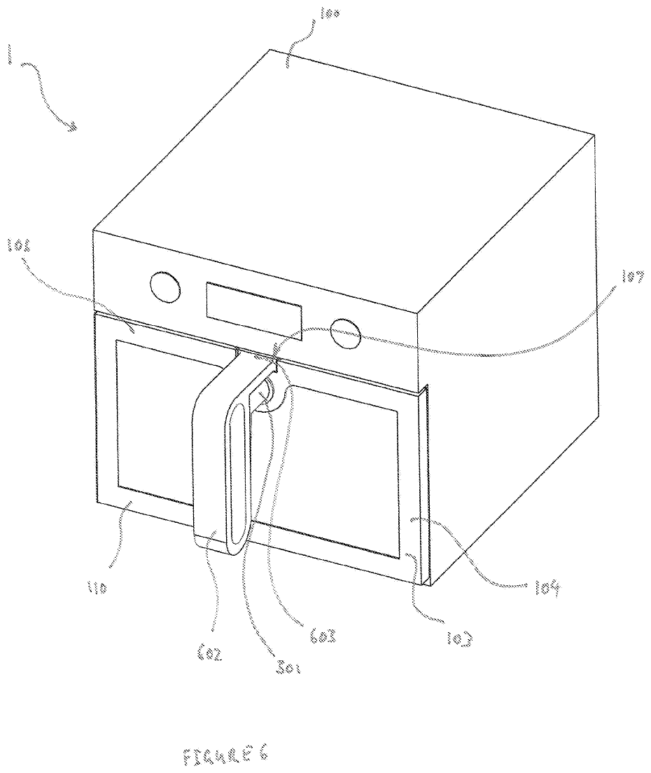

With reference to FIG. 6, shown is the FIG. 5 oven 1 with accessory 6 in place slid into its closed position. In comparing FIGS. 5 and 6, it is evident that the attached accessory 6 linearly translates along the extension axis to the closed position along with the door 103 without any substantial change in orientation in any other axis. Accordingly, the accessory 6 is not substantially tilted or dropped, which may otherwise lead to items such as foodstuffs associated with the internal portion 601 being spilt. Also evident from FIG. 6 is the external portion 602 of the accessory 6 being accessible despite the opening 101 to the interior chamber 102 being occluded, with the recess 107 in the upper portion of the door 103 being occupied by the connecting portion 603 of the accessory 6.

The example accessory 6 is specially adapted for used with the example oven 1 in its second condition, as it attaches to the door 103 which is translated between its open and closed positions without substantially changing its angular position. By this arrangement the accessory 6 is similarly translated along the extension axis of the door 103 without substantially changing its angular position, which may otherwise cause items such as foodstuffs to spill from the accessory 6. Also, the open position of the door 103 in its second condition sees it displaced from the oven body 100 along the extension axis, thus providing space between the door 103 and the body 100 for the accessory 6 to be lowered into its in-use position shown in FIG. 5.

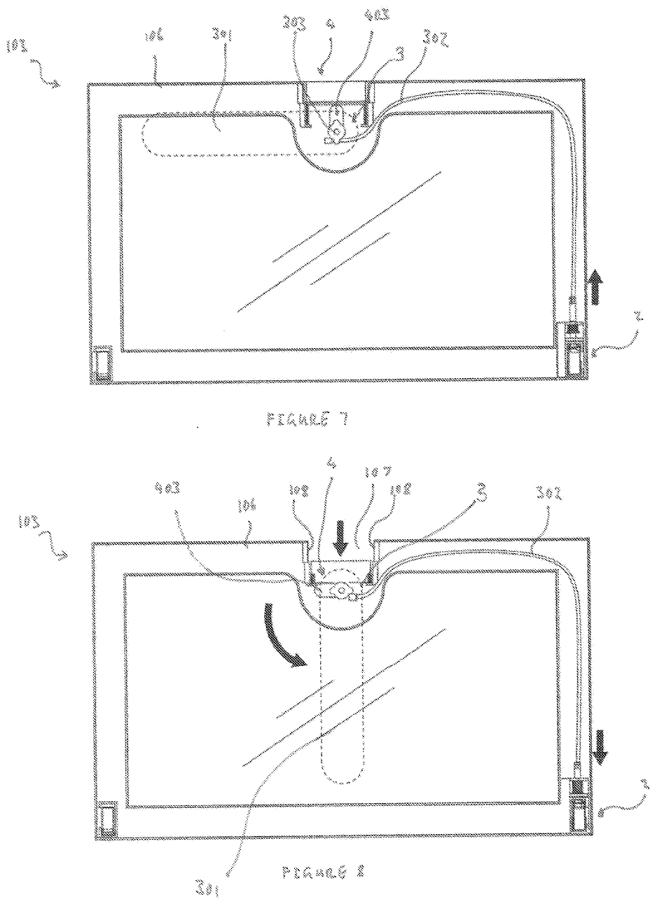

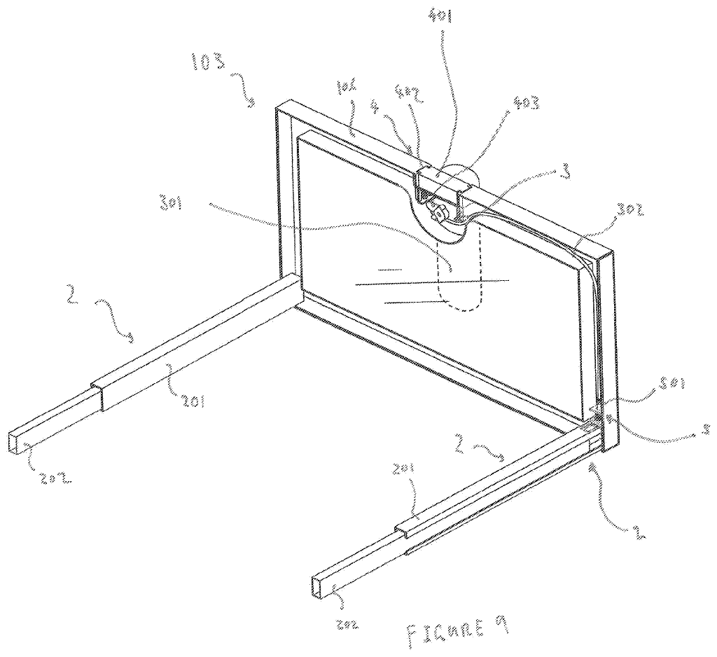

With reference to FIGS. 7 and 8, shown is a non-limiting example embodiment of an oven door 103 in the first condition and the second condition respectively. The door 103 may include an actuation assembly 3 to facilitate selection of the operating mode of the door 103 into its first condition or its second condition. The actuation assembly 3 may include an actuator 301 operable by a user to effect selection of the door 103 operating mode. In the example embodiment depicted, the actuator is in the form of an elongated handle 301, though other arrangements are within the scope of the present disclosure. In an alternative embodiment, selection of the operating mode may be automatically affected by an electronic control module depending on a cooking program being executed, such that a manually operated actuator 301 may not be required. In other embodiments, mode selection may be affected by a user entered command via a control interface, such as a push-button, switch or touchscreen input thereby instructing an electronic control module to select the operating mode of the door 103 without need of a manual actuator 301 such as a handle.

The actuation assembly 3 may include an actuation linkage 302 between the actuator 301 and a selector assembly 5 for the door 103 mode. In the depicted embodiment, the actuation linkage 302 is an actuation cable 302 in operative connection with the actuator 301 by a spindle 303. Rotation of the actuator 301 similarly effects rotation of the spindle 303 to increase or decrease tension of the operatively connected actuation linkage cable 302. In the depicted non-limiting embodiment of FIG. 7, turning the handle 301 to a horizontal position tightens the cable to actuate the selector assembly 5 to configure the door 103 into its first condition. In the depicted non-limiting embodiment of FIG. 8, turning the handle 301 to a vertical position loosens the cable 302 to actuate the selector assembly 5 to configure the door 103 into its second condition. The specific configuration of the actuation assembly 3 disclosed by FIGS. 7 and 8 is to be understood as a non-limiting example embodiment, and that other arrangements are within the scope of the present disclosure. For example, the actuation linkage 302 may be provided in the form of linkage arms or the like. If actuation of the selector assembly 5 is affected by an electronic control module, the actuation linkage 302 may be electronic and involve servo motors, solenoids and the like, as well as electrical communication linkage between the actuator 301 and the selector assembly 5.

As depicted in FIGS. 7 and 8, the actuation linkage 302 may be routed internally of the door 103 between an outer surface 104 and an inner surface 105 of the door 103. The actuation linkage 302 may be routed internal of the door frame 110 surrounding the door window 111 used to view the interior chamber 102 when the door 103 is closed. In this example embodiment, the actuator 301 and spindle 303 are mounted at an upper centre position on the outer surface 104 of the door 103 proximal to the recess 107, however, other arrangements are possible and within the scope of this disclosure. Also as depicted in the example embodiment of FIGS. 7 and 8, the selector assembly 5 is located internal of frame 110 between an inner surface 105 and an outer surface 104 of the door 103. The selector assembly 5 may locate at a lower corner position internal of the frame 110 proximal to the mounting assembly 2 of the door 103, however other arrangements are possible and within the scope of this disclosure.

Also shown in the non-limiting example embodiments of FIGS. 7 and 8 is a sealing assembly 4 for occluding the recess 107 in the door 103. The sealing assembly 4 includes a sealing member 401 to selectively occlude the recess 107. The sealing member 401 is configured to slide between a first position adapted to seal against the recess 107, and a second position adjacent to and thus exposing the recess 107. The sealing assembly 4 further includes a cam 403 mounted to the spindle 303 for co-rotation therewith. By this arrangement, with the actuator 301 rotated to the horizontal position of FIG. 7 affecting the first condition of the door 103, the cam 403 acts against the sealing member 401 to slide it upwards into the first condition occupying the space of the recess 107. As the actuator 301 is rotated to the vertical downwards position of FIG. 8 affecting the second condition of the door 103, the cam 403 rotates away from the sealing member 401, which in turn slides downwards to its second position adjacent to the recess 107. In embodiments the sealing member 401 may be biased into its second position to assists its sliding transfer downwards adjacent the door 103. In some embodiments, gravity may be sufficient to assist the downwards movement of the sealing member 401 in its second position.

This example embodiment operatively connects the position of the sealing member 401 with the condition of the door 103, whereby the actuating the door 103 into its pivoting first condition simultaneously occludes the recess 107 and cycling the door 103 into its sliding second condition simultaneously reveals the recess 107. It is envisaged that this non-limiting embodiment may have advantage where the oven 1 in the first condition having a pull-down pivoting door 103 is to be used as a conventional-style oven not requiring a recess 107 for accessories; and, and where the oven 1 in its second condition having a pull-out sliding door 103 is intended to be used as an air fryer, such that an accessory 6 in the form of a basket can be lowered and raised into attachment and detachment with the open second condition door 103 by virtue of the connecting portion 603 engaging with the recess 107 as hereinbefore described.

However, it is to be understood that the scope of the present disclosure is not limited to the preceding arrangement. For example, in certain embodiments the position of the sealing member 401 is not affected by the condition of the door 103, but rather may be actuated separately. In such an embodiment, an electronic control module may communicate with an actuator 301 to set the position of the sealing member based on user inputs from a control panel. Alternatively or in addition, a separate manual actuator to the door 103 actuator 301 may be provided to select the position of the sealing member 401, such as a sliding toggle by way of non-limiting example. In other embodiments, the sealing member 401 may simply be a manual plug that can be manually placed into occluding engagement occupying the space of the recess 107, and then removed to reveal the recess 107 when use of an accessory 6 requiring the recess is desired.

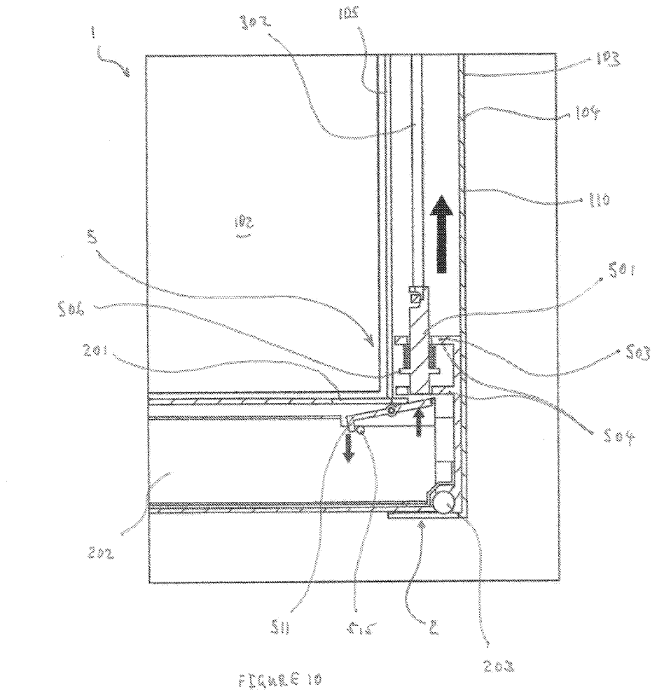

With reference to FIG. 9, shown is a non-limiting example embodiment of an oven door 103 in the second condition. In this embodiment the sealing member 401 is endowed with engagement features 402 corresponding with engagement features 109 of the recess 107. By this arrangement, secure translation between the first and second positions of the sealing member may be facilitated. As depicted in this non-limiting example, the edge surfaces of the sealing member 401 are adapted with a longitudinal raised protrusions 402 sized for engaging receipt by the channels 109 formed in the sidewalls 108 of the recess 107. This arrangement limits sliding movement of the sealing member 401 to between its first and second positions, with the protrusions 402 captured by and tracking along the grooves 109.

In the non-limiting embodiment of FIG. 9, the bottom corners of the door 103 connect with mounting assemblies 2 to affect attachment of the door 103 with the oven body 100. The mounting assembly 2 may include running tracks, telescoping rails or the like to facilitate the sliding draw-like operability of the door 103 in its second condition. The mounting assembly 2 may include a sliding portion 201 in operative association with a fixed portion 202. The fixed portion 202 is adapted for connection with the oven body 100, for example within a cavity formed within the oven body 100. The sliding portion 201 is adapted for reciprocal or sliding movement with respect the fixed portion 202, such that it is similarly configured for reciprocal movement with respect to the oven body 100. The sliding portion 201 is further configured for attachment to the oven door 103, such that door 103 is similarly configured of reciprocal movement with respect to the fixed portion 202 and the oven body 100. In embodiments, the sliding portion 201 projects from the oven body 100 when the door 103 is in the open position, and retracts to a position within the oven body 100 when the door 103 is in a closed position, such as a cavity formed within the oven body 100 also housing the associated fixed portion 202 of the mounting assembly 2.

In the depicted example embodiment of FIG. 9, the fixed portion 202 and sliding portion 201 are in telescoping relation. The fixed portion 202 is an elongated member received within an internal channel of the sliding portion 201 which is also provided as an elongated member. By this arrangement, the sliding portion 201 can slide along the fixed portion 202 acting as a guide. However, it is to be understood that other mounting assemblies whereby the door 103 is affected for reciprocal sliding movement with respect to the oven body 100 are within the scope of this disclosure.

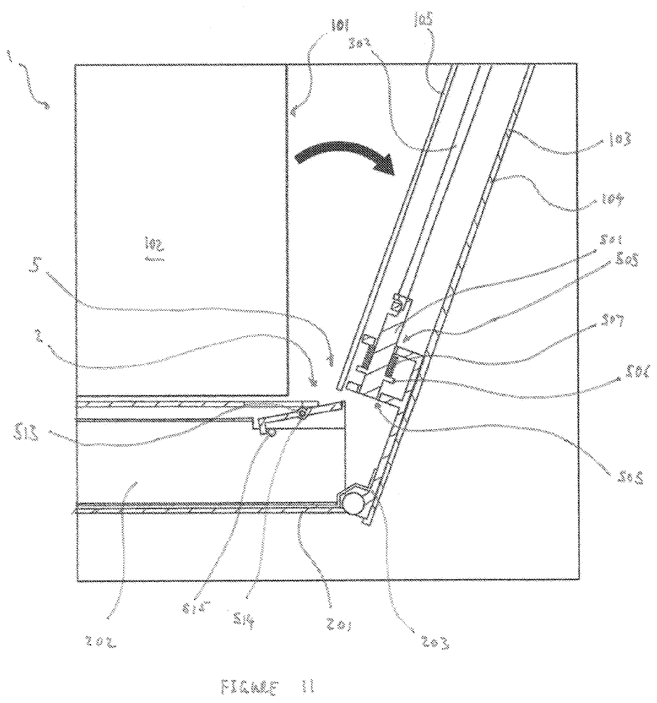

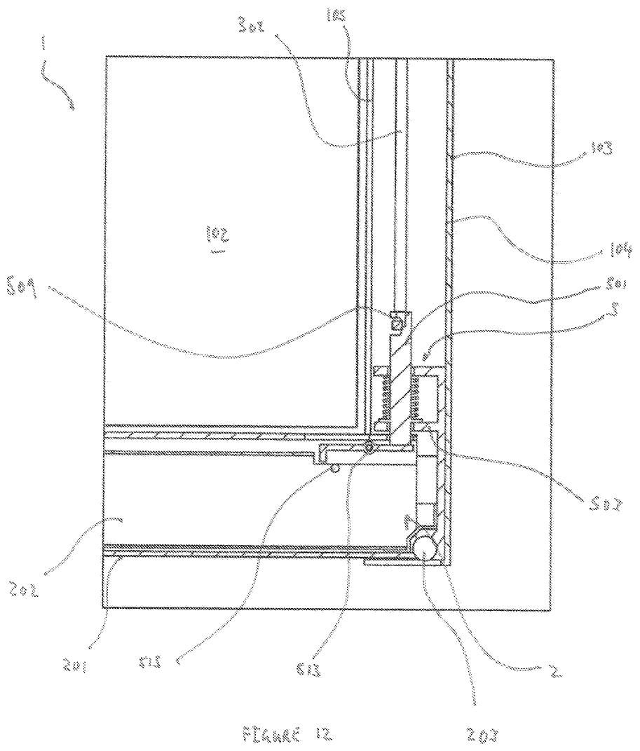

With reference to FIGS. 10 and 11, show is a non-limiting example embodiment of the oven door 103 in the first condition in open and closed positions respectively. The mounting assembly 2 includes a pivoting portion 203 to affect the pivoting operation of the door 103 in its first condition. In the depicted example embodiment, the pivoting portion 203 acts between the door 103 and the sliding portion 201 of the mounting assembly 2 such that the door 103 is pivotably movable relative to the sliding portion 201. By this arrangement with the door 103 in the first condition whereby the sliding portion 201 is fully retracted with respect to the oven body 100, the door 103 is similarly pivotable with respect to the oven body 100 such that it can be pivoted between an opened and a closed position to occlude the opening 101 to the interior chamber 102. In example embodiment, the pivoting portion 203 may be in the form of a hinge having pivotable leaves, with one said leaf being associated with the sliding member and another said leaf being associated with the door 103.

Also depicted in FIGS. 10 and 11 is a non-liming example embodiment of a selector assembly 5 operable to select the operating condition of the door 103 as either the pivotable first condition or the slidable second condition. Operation of the selector assembly 5 may be affected by the actuation assembly 3. The selector assembly 5 may include separate mechanisms associated with selection of pivoting functionality or sliding functionality, however said separate mechanisms may be operatively associated whereby affecting the state of one such mechanism in turn affects the state of the other such mechanisms. Although the embodiments of the Figures detail a single selector assembly 5 associated with one of the mounting assemblies 2, other embodiments are envisaged with each of the mounting assemblies 2 being associated with a selector assembly 5.

With reference to the non-limiting example embodiment of FIGS. 10 to 13, the selector assembly 5 includes a first engagement member 501 operable to selectively engage pivoting functionality of the door 103. The selector assembly 5 further includes a second engagement member 502 operable to selectively engage sliding functionality of the door 103. The example first engagement member 501 is in the form of a reciprocal bolt or plunge pin. This bolt 501 is located internal of the door 103 between a first surface and a second surface of the door 103. The bolt 501 is positioned at a lower corner of the door 103 proximal to the sliding portion 201 of the mounting assembly 2 in its retracted position. A mounting frame 503 within the door 103 may be provided, with the bolt 501 slidably mounted thereto for reciprocal movement between an engaged position whereby the door 103 in its pivotally closed position in fixed in relation to the sliding portion 201; and, a disengaged position, where the door 103 is pivotable between its open and closed position. In the depicted example embodiment, the mounting frame 503 is formed as an extension of a leaf of the pivoting portion 203 associated with the door 103, such that the mounting frame 503 and said leaf are integrally formed. However, in alternative embodiments, the mounting frame 503 may be provided as a separate component.

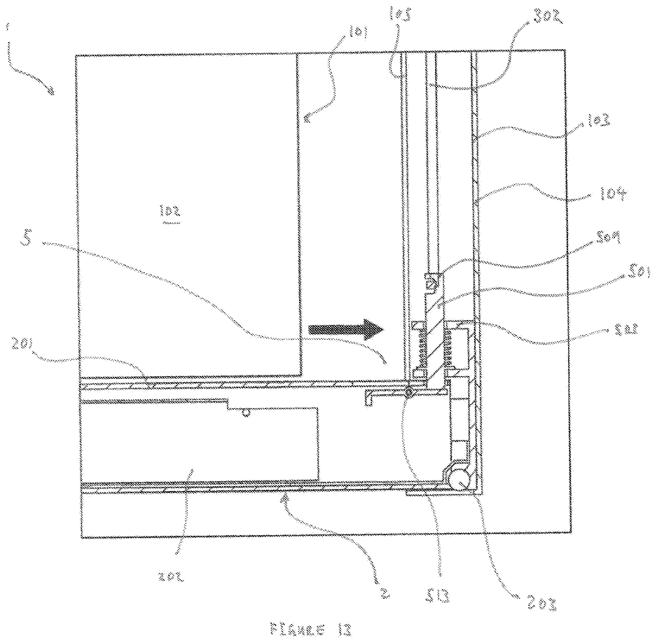

The example mounting frame 503 has two spaced mounting members 504 each having an aperture 505 in mutual alignment to slidably receive the first engagement member 501 in the form of a bolt. The bolt 501 is configured with expanded portion 506 with a direction of extension transverse to the sliding axis. One or more biasing members 507 may be provided to bias the bolt 501 into its engaged or disengaged position depending on the particular arrangement of the selector assembly 5. In the depicted example embodiment of FIGS. 12 and 13, the bolt 501 is biased into its engaged position, with the bolt 501 thus urged downwardly in the frame of reference of the door 103 in a pivotally closed position. The one or more biasing members 507 may act between the expanded portion 506 of the bolt 501 and one of the mounting members 504. In the depicted embodiment, the biasing members 507 act between the expanded portion 506 and the upper of the mounting members 504 to urge the bolt 501 downwardly.

The expanded portion 506 may also serve to slidably retain the bolt 501 in association with the mounting frame 503. In the depicted example, the expanded portion 506 locates between the mounting members 504 of the mounting frame 503. The expanded portion 506 may extend along an axis to a greater extent than the aperture 505 of one or both of the mounting members 504, such that the expanded portion 506 abuts with a part of the respective mounting member 504 adjacent to the aperture 505, thereby restricting travel of the bolt 501 through said aperture 505.

The depicted non-limiting example bolt 501 has a first end 508 acting as a bolt striker and an opposing second end 509 configured for operative connection with the actuation assembly 3. As the example actuation assembly 3 employs an actuation linkage 302 in the form of a cable, said cable 302 attaches with the second end 509 such that applying tension to the cable transfers a corresponding force to the bolt 501 in an upwards direction against the urging of the biasing member 507. Conversely, when the cable 302 is not sufficiently tensioned to position the bolt 501 upwardly against the urging of the biasing member 507, the bolt 501 is instead urged downwardly assisted by the urging of the biasing member 507.

The first end 508 of the bolt 501 is adapted to act as a striker 508 to selectively engage with a bolt keeper 510 to either facilitate or restrict pivotal functionality of the door 103. With reference to FIG. 10, shown is a closed door 103 with the bolt 501 urged upwardly by cable tension to define a disengaged position with the striker 508 retracted out of engagement with the bolt keeper 510. With reference to FIG. 11, shown is a door 103 with the bolt 501 is a disengaged position thereby releasing the door 103 for to be pivotally opened via the pivotal member. With reference to FIG. 12, shown is a closed door 103 with the bolt 501 urged downwardly under assistance from the biasing member 507. Here the end of the bolt 501 acting as the striker 508 is received by an aperture 510 in the sliding portion 201 acting as a bolt keeper 510, thereby preventing the door 103 from being pivoted open thus defining the engaged position of the bolt 501. Also shown in FIG. 12 is the expanded portion 506 abutting with the lowermost mounting member 504 preventing any further downwards movement of the bolt 501.

Still referring to the non-limiting example embodiment of FIGS. 10 to 13, the selector assembly 5 includes a second engagement member 502 operable to selectively engage sliding functionality of the door 103. The example second engagement member 502 is in the form of a latch configured for reciprocal rocking or pivoting movement about a fulcrum 513 between an engaged position whereby the sliding functionality of the door 103 is disabled, and a disengaged position whereby sliding functionality of the door 103 is enabled. The latch 502 is configured to act between the sliding portion 201 and the fixed portion 202 to prevent or allow sliding movement between the sliding portion 201 and the fixed portion 202 in the engaged and disengaged position of the latch respectively. The latch may be mounted to the sliding portion 201 of the mounting assembly 2, such that the fulcrum 513 is fixed in fixed relation in respect to the sliding portion 201.

FIG. 12 shows an example embodiment of the latch 502 with the door 103 in the closed position with a retracted sliding portion 201. The latch 502 has a first end 511 configured to selectively engage with the fixed portion 202, either directly or indirectly, in order to prevent or release the sliding portion 201 to slidably extend with respect to the fixed portion 202. The first end 511 is a latching end in a form such as a hook or catch configured to engage with some engaging feature 515 associated with the fixed portion 202 or the oven body 100 to prevent extension of the sliding portion 201. In the depicted embodiment, the latching end 511 is in the form of a hook or catch for capturing an engagement feature 515 in the form of a tab or projection from the fixed portion 202. With the latching end 511 hooked over the tab 515 as shown in FIGS. 10 and 11, the sliding portion 201 is prevented from extending relative the fixed portion 202and oven body 100, thereby defining the engaged position of the second engagement member 502.

The depicted example embodiment second engagement member 502 includes a second end 512 providing an action surface to facilitate actuating the first end 511 between the engaged and disengaged positions. The second engagement member 502 fulcrum 513 locates between its first end 511 and its second end 512 thus configuring the latch 502 with back and forth rocking or see-saw movement. By this arrangement applying a force to the second in a first direction normal to the latch 502 long axis will cause the latch 502 to pivot about the fulcrum 513 inducing a force on the first end 511 in a second direction opposite the first direction. Similarly, application of a force on the second end 512 in the second direction will induce a force on the first end 511 in the first direction. With reference to FIG. 10, shown is a force vector in an upwards direction applied to the second end 512 resulting in the second end 512 being pivoted upwards about the fulcrum 513. Also shown is the opposing downwards force vector induced on the first end 511, resulting in the first end 511 being brought downwards into latching engagement with the engaging feature 515, thereby placing the second engagement member 502 in its engaged position restricting sliding extension of the sliding portion 201 from its retracted position associated with a closed door 103 in its second condition.

The actuating force on the second end 512 may be applied by some feature of the selector assembly 5. As hereinbefore described, the first engagement member 501 is adapted to reciprocate downwards under urging from its associated biasing member 507 to enter its first position with its striker end 508 received by the bolt keeper 510 associated with the sliding portion 201. The second end 512 of the second engagement member 502 may be located proximally to the bolt keeper aperture 510. The second end 512 of the second engagement member 502 may be aligned with the bolt keeper aperture 510 along the reciprocal axis of the first engagement member 501. As shown in FIGS. 12 and 13, the first engagement member 501 is adapted such that when in its engaged position with the striker 508 received by the bolt keeper 510, the striker 508 also impinges on the second end action surface 512 of the second engagement member 502. In the depicted embodiment, this induces the second end 512 to pivot downwardly thereby inducing the first end 511 to pivot upwards about the fulcrum 513 out of latching engagement with the fixed portion 202 engaging feature 515. By this arrangement, an operational association exists between the actuation assembly 3 and the first 501 and second 502 engagement members of the selector assembly 5. Using the actuation assembly 3 affect the first engagement member 501 into its engaged position to disable pivoting function of the door 103 correspondingly affects the second engagement member 502 into its disengaged position enabling sliding functionality of the door 103. Thu the door 103 may be slidably opened while maintaining the door 103 in its pivotally closed orientation relative the sliding portion 201 as shown in FIG. 13.

In the example embodiment depicted in FIGS. 10 to 13, the second engagement member 502 is biased into its engaged position. For example, the second engagement member 502 may associate with a biasing member 514 in the form of a torsion spring axially aligned with the fulcrum 513. By this arrangement and with reference to FIG. 10, using the actuation assembly 3 to tension the cable 302 and reciprocate the first engagement member 501 upwards to affect its disengaged position releasing the door 103 for pivotable movement also withdraws the first end 508 of the bolt 501 from the bolt keeper 510 and out of impinging contact with the second end 512 of the second engagement member 502. In the absence of the bolt 501 forcing the second end 512 of the second engagement member 502 downwards, it is instead urged upwards under bias to correspondingly pivot the first end 511 downwards into its latching engagement with the fixed portion 202, thereby affecting the engaged position of the second engagement member 502 and disabling sliding functionality of the sliding member and door 103. Accordingly, the door 103 is affected into its first condition and may be pivoted open as shown in FIG. 11.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

As used herein, a cooking appliance may refer to a conventional oven, a convection oven, a compact oven and a toaster over as well as a microwave oven, an air fryer, and any other appliance having an interior cooking chamber selectively occluded by a door.

### PARTS LIST

1 Appliance/oven
100 body
101 opening
102 interior chamber
103 door
104 outer door surface
105 inner door surface
106 upper edge periphery
107 recess in upper edge periphery of door
108 sidewalls of recess
109 engaging features of recess
110 door frame
111 door window
2 mounting assembly
201 sliding portion
202 fixed portion
203 pivoting portion
3 actuation assembly
301 actuator/handle
302 actuation linkage/cable
303 actuator spindle
4 sealing assembly
401 sealing member
402 sealing member engagement features
403 cam
5 selector assembly
501 first engagement member/bolt
503 first engagement member mounting frame
504 mounting members
505 aperture of mounting members
506 expanded portion of bolt
507 first engagement member biasing member
508 first engagement member first end/striker
509 first engagement member second end
510 bolt keeper/aperture
502 second engagement member/latch
511 second engagement member first end/latching end
512 second engagement member second end (action surface)
513 second engagement member fulcrum
514 second engagement member biasing member
515 engaging feature for second engagement member (eye)
6 accessory
601 internal portion (air-fryer basket)
602 external portion (accessory handle)
603 connecting portion (internal part)
604 connecting portion corresponding engagement features

1. An appliance having a body defining an interior chamber to receive foodstuffs and a door operable to selectively occlude the interior chamber; wherein,
the door is mounted to the body by way of a mounting assembly including:
a sliding portion configured to extend from the body such that the door is slidable between a slidably open and a slidably closed position relative to the body; and,
a pivoting portion such that the door is pivotable between a pivotably open and a pivotable closed position.

2. The appliance of claim 1, wherein the mounting assembly includes a fixed portion adapted for connection to the oven body in a fixed relation, wherein the sliding portion retracts relative to the fixed portion towards the slidably closed position, and extends relative the fixed portion towards the slidably open position.

3. The appliance of claim 2, wherein the fixed portion is configured to substantially locate within the body.

4. The appliance of claim 2 or 3, wherein the sliding member is in telescoping arrangement with the fixed member.

5. The appliance of any one of the preceding claims, wherein the pivoting portion acts between the door and the sliding portion such that the door is pivotable in relation to the sliding portion.

6. The appliance of any one of the preceding claims, wherein the door is configurable into:
a first condition latched in the slidably closed position, and pivotable between the pivotably open position allowing access to the interior chamber and the pivotably closed position restricting access to the interior chamber; and,
a second condition latched in the pivotably closed position, and slidable between the slidably open position allowing access to the interior chamber and the slidably closed position restricting access to the interior chamber.

7. The appliance of claim 6, wherein the door is user selectable into the first condition or the second condition.

8. The appliance of claim 6, wherein the door is user selectable into the first condition or the second condition by way of an actuator assembly.

9. The appliance of claim 8, wherein the actuator assembly includes an actuator positioned on the door.

10. The appliance of claim 8 or 9, wherein the actuator is a handle rotatable to select the first position or the second position.

11. The appliance of any one of the preceding claims, further including a recess formed in the upper edge periphery of the door, and a sealing member operable to selective occlude the recess.

12. The appliance of claim 11 when appended to any one of claims 8 to 10, wherein the sealing member is operatively connected with the actuator assembly, and wherein operation of the actuator to select the first condition of the door correspondingly places the sealing member into position to occlude the recess, and operation of the actuator to select the second condition correspondingly places the sealing member into position to expose the recess.

13. The appliance according to claim 12, wherein the actuator is operatively associated with a cam adapted to place the sealing member into position to occlude the recess.

14. The appliance according to claim 13, wherein the sealing member is biased into position to expose the recess.

15. The appliance according to any one of claims 11 to 14, wherein the recess is adapted to receive an oven accessory.

16. The appliance according any one of claims 11 to 14, wherein the actuator is a handle rotatable to select the first position or the second position, wherein the handle is orientated downwards to select the second condition, wherein the recess is adapted to receive a first portion of an oven accessory, said first portion sized to occlude the recess when received thereby.

17. The appliance according to any one of claims 8 to 16, further including a selector assembly operatively associated with the actuator assembly to select either the first condition or the second condition.

18. The appliance according to claim 17, wherein the selector assembly includes a first engagement member having an engaged position whereby the pivoting portion is latched in the pivotably closed position; and, a disengaged position wherein the pivoting portion is unlatched for movement between the pivotably closed and the pivotably open position.

19. The appliance according to claim 17 or claim 18, wherein the selector assembly includes a second engagement member having an engaged position whereby the sliding portion is latched in the slidably closed position; and, a disengaged position wherein the sliding portion is unlatched for movement between the slidably closed and the slidably open position.

20. The appliance according to claim 19, wherein the first engagement member and the second engagement member are in an interlockable relation with said first condition and said second condition being mutually exclusive.

21. The appliance according to claims 19 to 20, wherein the first engagement member and the second engagement member are operatively connected, and wherein configuring one of the first or second engagement members into the engaged position will correspondingly configure the other of the first and second engagement members into the disengaged position.

22. The appliance according to any one of claims 19 to 21, wherein the first engagement member and the second engagement member are operatively connected, and wherein configuring one of the first or second engagement members into the disengaged position will correspondingly configure the other of the first and second engagement members into the engaged position.

23. The appliance according to any one of claims 19 to 22, wherein the first engagement member and the second engagement member are operatively connected whereby actuation of the first engagement into the disengaged position correspondingly actuates the second engagement member into the engaged position thereby defining the first condition of the door.

24. The appliance according to any one of claims 19 to 23, wherein the first engagement member and the second engagement member are operatively connected whereby actuation of the first engagement into the engaged position correspondingly actuates the second engagement member into the disengaged position thereby defining the second condition of the door.

25. The appliance according to any one of claims 19-24, wherein the actuator is operable to actuate the first engagement member into the disengaged or engaged position.

26. The appliance according to any one of claims 18-25, wherein the first engagement member is mounted in association with the door.

27. The appliance according to claim 26, wherein the first engagement member locates within the door, between an outer surface of the door and an inner surface of the door.

28. The appliance according to claim 27, wherein the first engagement member is mounted to a frame within the door.

29. The appliance according to any one of claims 18 to 28, wherein the first engagement member is biased into its engaged position.

30. The appliance according to any one claims 18 to 29, wherein the first engagement member is a bolt configured to reciprocate between its engaged position and its disengaged position.

31. The appliance according to claim 30, wherein the first engagement member is configured to be received by a bolt keeper associated with the sliding portion when the first engagement member is in the engaged position thereby defining the second condition of the door.

32. The appliance according to claim 31, wherein the first engagement member is biased into the disengaged position out of engagement with the bolt keeper.

33. The appliance according to claim 31 or 32, wherein the bolt keeper is an aperture in the sliding portion.

34. The appliance according to any one of claims 19-33, wherein the actuator is operable to actuate the second engagement member into the disengaged or engaged position.

35. The appliance according to any one of claims 19-34, wherein the second engagement member is mounted in association with the sliding portion.

36. The appliance according to any one of claims 19-35, wherein the second engagement member is a latch having a fulcrum mounted in fixed relation to the sliding portion.

37. The appliance according to claim 36, wherein the latch has a latching end pivotable about the fulcrum in a first direction into the engaged position and a second direction into the disengaged position.

38. The appliance according to claim 37, wherein the latch has a second end opposite the fulcrum to the first end, said second end locating proximal to an aperture in the sliding portion defining the bolt keeper, whereby actuation of the first engagement member into the engaged position received by the bolt keeper causes the first engagement member to impinge on the second end of the second engagement member thereby pivoting the first end of the second engagement member about the fulcrum into the disengaged position.

39. The appliance according to claim 38, wherein the second engagement member is biased into the engaged position.

40. An appliance accessory for use with the oven of any one of claims 11 to 16 having a first portion sized to occlude the recess when received thereby.

41. The appliance accessory of claim 40 when any one of claims 11 to 16 are appended from claim 10, further having a second portion adapted to receive the handle selecting the second condition.

42. The appliance accessory of claim 41, wherein the second portion is adapted to slip over the handle selecting the second condition.

43. The appliance accessory of any one of claims 40-42, wherein the oven accessory is an air fryer basket.

44. An appliance having a body defining an opening and a door operable to selectively occlude the opening; wherein, the door is configurable into:
a first condition whereby the door is slidable between a slidable open position and a slidably closed position; and,
a second condition whereby the door is pivotable between a pivotably open position and a pivotably closed position.

45. A method of operating a door of an appliance, including the method steps of selectively either:
sliding the door between a slidable open position and a slidably closed position; or
pivoting the door between a pivotably open position and a pivotably closed position.

46. The method according to claim 45, further including the step of selecting, via an actuator, either sliding or pivoting function of the door.
